(19) United States
(12) Patent Application Publication
(10) Pub. No.: US 2008/0263950 A1
(43) Pub. Date: Oct. 30, 2008

(54) NATURAL OR ARTIFICIAL CULTURE SUPPORTS AND PRESERVATION MEDIA FOR CUT FLOWERS ENRICHED WITH ACTIVE SUBSTANCES

(76) Inventors: Jean MORELLE, PARIS (FR); Eliane LAUZANNE, PARIS (FR); Jacqueline ROTHFUSS, LAUTERBOURG (FR); Christophe DE MIL, PARIS (FR)

Correspondence Address: LUCAS & MERCANTI, LLP, 475 PARK AVENUE SOUTH, 15TH FLOOR, NEW YORK, NY, 10016, US

(21) Appl. No.: 11/925,475

(22) Filed: Oct. 26, 2007

Related U.S. Application Data
(62) Division of application No. 10/477,024, filed on Mar. 10, 2004, now abandoned.

(30) Foreign Application Priority Data
May 4, 2001 (FR) 01/05965

(51) Int. Cl. A01G 31/00

(52) U.S. Cl. 47/59 S

(57) ABSTRACT

The invention concerns natural or artificial culture supports and preservation media for cut flowers enriched with active substances. Said active substances consist in acylamino acids salified or not by basic amino acids, or by trace minerals, some of which being endowed with antioxidant properties. The invention also concerns culture supports and media for preserving cut flowers enriched with butyric or free caprylic acids, or salified by basic amino acids or by trace elements, as well as by plant extracts, characterized by their antioxidant properties.

### RELATED APPLICATIONS

This is a divisional application on the U.S. patent application Ser. No. 10/477,024, filed on Mar. 10, 2004, which is a national phase application based on PCT/FR0201527, filed on May 3, 2002, with a priority claim of the France application No. 01/05965 filed on May 4, 2001.

### SPECIFICATION

The quality of natural or artificial cultivar mediums are very important throughout the plant growth process, beginning with seed germination, for the development of the seedlings. This is also true for other plant reproduction processes (propagation by cuttings, layering).

In the case of floral and truck farming cultivars, seeding is generally accomplished using a compost enriched with mineral and organic elements such as plant and animal wastes: solid manure, liquid manure, bark, leaves, peat, clay, sand, bone powder (proteins, calcium phosphate), or ground hoof and horn (keratin) to which metallic oxides, ground oyster shell and other waste products are added. Hydroponic and soilless cultivation methods use artificial elements such as vermiculite and perlite, enriched with various nutritive substances necessary for germination and the development of the seedling.

The seedling is vulnerable to degradation from lipoid peroxydation; it contains unsaturated fatty acids in varying degrees (depending on the plant); pulses contain from 10% to 20%. Hydroperoxides develop, leading to the production of various aldehydes (hexanal, malondialdehyde) which are markers of the oxidative degradation of lipids. These aldehydes are combined with basic protein functions. It is known that the enzyme SOD (superoxide dismutase), which contains zinc and manganese, is inhibited by lipoperoxydation. The observed effect is a significant reduction in germination. (HALSTONES M., SMITH N., Physiol Plant 1988, 122 (4) 452).

The mature plant is protected from oxidation by its synthesis of polyphenols, a substance that seeds are deficient in. Thus the benefit of introducing organic antioxidants, zinc and manganese into various cultivar mediums.

Seeds should accumulate Mg (magnesium) which enables the synthesis of chlorophyll in chloroplasts. Thus the need for introducing magnesium that is easily assimilated into various cultivar mediums.

Plants also need additional nitrogen, principally at the seedling stage. Glutamine is an amino acid which provides this indispensable substance in a form that is easily assimilated and stored by the plant. Enriching crops with glutamine provides seedlings with a supply of organically active nitrogen at the end of the germination process.

It is known that in plant life, the biosynthesis of fatty acids takes place in the butyric acid chain; thus it follows that cultivated plants should be supplemented with this type of fatty acid.

The germination process requires the presence of sulfur which is indispensable for the synthesis of reduced glutathione (GSH), thus it follows that it would be beneficial to introduce sulfur in various cultivar mediums, either directly, in the form of acylated cysteine or cystine, or in the form of an acylated methionine, a precursor of cysteine.

We know that the germination process can be inhibited by the intervention of microorganisms or parasites (nematodes). Thus it follows that it would be beneficial to introduce organic molecules with anti-micro organic, antiviral and anti-parasitic, such as caprylic acid, free or salified caprylyl amino acids. Salification with copper is particularly interesting to achieve this type of effect.

In the case of cut flowers, it is a matter of stopping the rapid deterioration of the plant stems due to the bacterial and oxidative activity that takes place in an aqueous environment.

Various components which have no relation to antioxidative protection have been described; bacterial protection is generally achieved with various antibacterial agents. Citing patents CA 1.153 271, which advocates the use of thioure and acetic and propionic acids. Patent CA 2.0577351 advocates nitrogen monoxide, patent CA 2.0220751 advocates polyaspartic and phosphoric acids. It would therefore be beneficial to utilize organic antioxidant and anti-micro organism complexes.

Organic structures, such as acyl amino acids correspond either to combinations of organic acids (C₂: acetic, C₃: propionic) or to combinations of fatty (C₄ to C₂₂) and amino acids. These different types of acylated substances are salified or not by oligoelements or by basic amino acids. Such structures were previously advocated for the treatment of plants cultivated on a large scale, such as wheat, barley, grapevine, beets, potatoes, for the flowering stage, for example in French patents N°2.403 024; 2.503 151; 2.503 153; 2.503 144;- E P: 0 218 504: 0 352 802; 0 373 314. English patents: 2.097 256, and German patents: DE 3 802 216: DE 3 212 448.

These organic structures have never been employed as additives to enrich artificial or natural cultivar mediums or as an agent introduced into the conservation environment of cut flowers. The object of the present invention is to improve the quality of cultivar mediums, artificial or natural, by the incorporation of the following compositions:

Acylated amino acids, of which the acyl fraction possesses from 2 to 22 atoms of carbon. The amino acid fraction concerns amino acids, individually acylated, or in compositions or also those derived from hydrolysates of all proteins.

These acyl amino acids can be salified or not, with basic amino acids (lysine or arginine) or by organic metals such as magnesium, zinc, manganese, and copper.

Among the acyl amino acids, we prefer to use those with the highest sulfur content—methionine, cysteine or cystine. The acyl amino acids containing methionine and cysteine are also employed for their antioxidant properties.

Let us specify that methionine is an amino acid with a high sulfur content, a precursor of the cysteine of reduced glutathione (GSH) which is vital to cellular development. Also acyl methionine destroys lipoperoxides.

One can also introduce acyl glutathione. This structure allows for a supply of nitrogen for the plant which can be directly assimilated and stored by it.

Butyric acid can also be employed to this purpose.

One introduces butyric acid, a precursor of fatty acids, either as an acid, or as a salt, for example butyrates of arginine, lysine, Zn, Mg, Cu or Mn.

Butyric acid can also be introduced in the form of a butyryl amino acid, salified or not, with arginine, lysine Zn, Mg, Cu or Mn.

To avoid the development of bacterial or parasitical agents, one can introduce caprylic acid as an acid, or in a salified form by basic amino acids (arginine, lysine), or oligoelements (Zn, Mg, Cu or Mn).

Butyryl amino acids and caprylyl amino acids can be created by combining the butyryl chain and the caprylyl chain, with either one amino acid (lipo mono-amino acids), or several amino acids (lipo poly-amino acids).

The invention equally extends to the addition of plant extracts, rich in antioxidants.

Vegetal extracts have an important capacity for lipoperoxide destruction. These capacities can be quantified: for example, nettle extract can neutralize 2000 μg of active lipoperoxidic oxygen; the extract of beet greens neutralizes 1,600 μg of active lipoperoxidic oxygen and the extract of green endive leaves neutralizes 1,500 μg of active lipoperoxidic oxygen.

The invention also consists of the utilization of acyl amino acids to improve the conservation of cut flowers. The acyl fraction will correspond to either that of acetic, propionic, butyric, or caprylic acids. These acyl amino acids can be used in their acid form or in a salified form, in powder, or hydrosolubilized by an emulsifier, either in the form of various solutions with a pH of between two (2) and four (4). One can also introduce vegetal extracts with strong antioxidant properties.

The incorporation of active substances, either artificial or natural, in cultivar mediums depends upon the types of mediums utilized, of the plant culture in question and upon the substances introduced therein.

For 100 g of medium, one would use from 0.05 g to 20 g of active substances.

In the case of active substances for the preservation of cut flowers, concentrations will range from 0.05 g to 20 g for one liter of solution.

The following is a partial listing of active substances incorporated into cultivar mediums or in an environment for cut flowers:

For cultivar mediums, in the following ratios/rapports:

| | | |
|---|---|---|
| 1) | Caprylyl collagenate of lysine | 2 |
| | Butyrylmethionate of magnesium | 2 |
| | Caprylylmethionate of lysine pH 3 | 2 |
| 2) | Caprylylcollagenate of copper | 3 |
| | Nettle extract | 3 |
| 3) | Acetylmethionate of zinc | 3 |
| | Extract of beet greens | 3 |
| 4) | Caprylylglutaminate of lysine | 3 |
| | Zinc butyrate | 3 |

From 0.5 g to 10 g of the above-mentioned solutions are indicated for 100 g of mediums.

For the preservation of cut flowers, in the following ratios:

| | | |
|---|---|---|
| 5) | Caprylylmethionic acid | 4 |
| | Polyoxyethylene emulsifier | 6 |
| 6) | Plant extract | 4 |
| | Caprylylcollagenate of lysine at pH 3 | 6 |

From 0.05 g to 20 g of the above-mentioned solutions are indicated for each liter of water.

1-8. (canceled)

9. A method for preventing oxidation of plants during the plant growth process, comprising:
putting the plant into an aqueous medium during seed germination;
adding an active substance which prevents oxidation to the medium, wherein the active substance comprises:
acyl amino acids of which the acyl fraction has from 2 to 22 atoms of carbon, the amino acid fraction consists of the amino acid either individually or in groups created from the hydrolysates of any proteins, and vegetal extracts with a high degree of antioxidant properties;
wherein said acyl amino acids are salified by basic amino acids which give them antioxidant properties.

10. The method of claim 9, wherein the active substance is present in an amount of 0.05-20 grams per 100 grams of the medium.

11. A method for stopping rapid deterioration of cut flowers, comprising:
putting stems of the cut flowers in water;
adding an active substance to said medium, wherein the active substance comprises:
acyl amino acids of which the acyl fraction has from 2 to 22 atoms of carbon, the amino acid fraction consists of the amino acid either individually or in groups created from the hydrolysates of any proteins, and vegetal extracts with a high degree of antioxidant properties;
wherein said acyl amino acids are salified by basic amino acids which give them antioxidant properties.

12. The method of claim 11, wherein the active substance is present in an amount of 0.05-20 grams per liter of water.
